(19) United States
(12) Patent Application Publication
(10) Pub. No.: US 2015/0204165 A1
(43) Pub. Date: Jul. 23, 2015

(54) APPARATUS AND METHOD FOR CONTINUOUSLY MIXING FLUIDS USING DRY ADDITIVES

(71) Applicant: SANJEL CORPORATION, Calgary (CA)

(72) Inventors: Tony Chun-Chung YEUNG, Calgary (CA); Ian Alexander Cornock DAY, Calgary (CA); Graham Paul DICK, Calgary (CA)

(73) Assignee: SANJEL CORPORATION, Calgary (CA)

(21) Appl. No.: 14/158,167

(22) Filed: Jan. 17, 2014

(51) Int. Cl. E21B 41/00; E21B 27/02; E21B 44/00; G01F 1/05

(52) U.S. Cl. CPC E21B 41/00; G01F 1/05; E21B 27/02; E21B 44/00

(57) ABSTRACT

An apparatus and system for producing a gel for the treatment of petroleum wells are disclosed herein. The apparatus comprises: a mixing fluid stream, the mixing fluid stream comprising: a mixing fluid inlet for accepting a mixing fluid; a first pump; a dry polymer inlet for accepting a dry polymer; a hydraulic mixer configured and adapted to mix the dry polymer with the mixing fluid to produce a concentrated gel; a dilution fluid stream for diluting the concentrated gel to produce a diluted gel, the dilution fluid stream comprising: a dilution fluid inlet for accepting a dilution fluid; a second pump; and an outlet coupled to the mixing fluid stream.

### FIELD OF TECHNOLOGY

The present invention relates generally to the production of a viscous aqueous gel, for use in, but not limited to, oilfield well treatment.

### BACKGROUND

The oil and gas industry relies on the production of oil and gas from reservoir rock. Oil and gas can be extracted from several different types of reservoir rock through several different methods. A common method of extracting oil and gas is from the use of a well and hydraulic fracturing. In simple terms, a well is constructed by drilling a wellbore into the surface ground and inserting a steel pipe which is then cased and cemented. Near the end of the well, at the total depth, the production casing can be perforated to allow access to reservoir rock. In order to extract oil and gas from such reservoir rock, a high viscosity fluid such as a hydraulic fracturing fluid can be pumped into the well. The pumping of a high viscosity fluid, fractures the rock at the end of the well allowing for optimal extraction of oil and gas, and thereby increasing the productivity of such wells.

Viscous fluids can be produced by many different means. Routinely, dry polymer is hydrated to create a viscous fluid for use in wellbore formations. Fluid properties commonly vary, for example by thickness and homogeneity. Variance in fluid properties can be particularly evident when high viscosity fluids are produced from dry polymer.

The above information is presented as background information only to assist with an understanding of the present disclosure. No determination has been made, and no assertion is made, as to whether any of the above might be applicable as prior art with regard to the present invention.

### SUMMARY

In a first aspect the present disclosure provides an apparatus for producing a gel for the treatment of an oilfield well, the apparatus comprising: a mixing fluid stream, the mixing fluid stream comprising: a mixing fluid inlet for accepting a mixing fluid; a first pump; a dry polymer inlet for accepting a dry polymer; a hydraulic mixer configured and adapted to mix the dry polymer with the mixing fluid to produce a concentrated gel; a dilution fluid stream for diluting the concentrated gel to produce a diluted gel, the dilution fluid stream comprising: a dilution fluid inlet for accepting a dilution fluid; a second pump; and an outlet coupled to the mixing fluid stream.

In some embodiments, the mixing fluid comprises clean water and the dilution fluid comprises produced water.

In various embodiments, the apparatus further comprises a first heater coupled to the mixing fluid stream for heating the mixing fluid. In some embodiments, the first heater heats a mixing fluid source that is coupled to the mixing fluid inlet. In some embodiments, the apparatus also comprises a second heater coupled to the dilution fluid stream for heating the dilution fluid. In some embodiments, the second heater heats a dilution fluid source that is coupled to the dilution fluid inlet.

In some embodiments, the apparatus further comprises a first flow meter coupled to the mixing fluid stream; and a second flow meter coupled to the dilution fluid stream. In various embodiments, the apparatus further includes a processor coupled to the first flow meter, the second flow meter, the first pump and the second pump. The processor is configured in some embodiments to control the first pump based on an output of the first flow meter and an output of the second flow meter.

In some embodiments, the apparatus further includes a dry polymer storage hopper; and a volumetric feeder coupled to the dry polymer storage hopper and the dry polymer inlet.

In some embodiments, the processor is further configured to control the volumetric feeder based on at least one of the output of the first flow meter and the output of the second flow meter. In various embodiments, the processor is further configured to control the first pump, the second pump, and the volumetric feeder to produce a diluted gel having a predetermined viscosity.

In some embodiments, the apparatus further comprises an input device configured to accept user input. The user input can, for example, include one or more of a desired gel concentration, desired gel viscosity, desired flow rate of either stream, desired total flow rate, and parameters of operation of at least one of the first pump and the second pump.

In some embodiments, the apparatus further comprises a storage tank coupled to the mixing fluid stream. In some embodiments, the dilution stream is coupled to the mixing fluid stream upstream of the storage tank while in other embodiments, dilution stream is coupled to the storage tank. The storage tank can, for example, be a hydration tank.

In some embodiments, the apparatus further comprises a dry polymer dispensing apparatus. The dry polymer dispensing apparatus comprises: a hopper having a loading port configured to receive a powder; at least one vacuum port adapted and configured to be coupled to a vacuum apparatus; a powder outlet configured to emit powder; and a mechanical metering device configured to dispense powder from the hopper to the outlet.

In some embodiments, the apparatus further comprises an outlet chamber between the metering device and the outlet chamber.

In some embodiments, when in use, the hydraulic mixer generates a vacuum.

In some embodiments, the apparatus further comprises a vacuum-breaking channel coupled between the hydraulic mixer and the outlet chamber.

In some embodiments, when in use, the vacuum-breaking channel breaks the vacuum between the powder outlet and the mixing device by providing fluid communication between the outlet chamber and the hydraulic mixer.

In various embodiments, the vacuum-breaking channel can comprises a hose, tube, pipe, or any other suitable channel.

In another aspect, the present disclosure provides an apparatus for dispensing a powder, the apparatus comprising: a hopper having a loading port configured to receive a powder; at least one vacuum port adapted and configured to be coupled to a vacuum apparatus; a powder outlet configured to emit powder; and a mechanical metering device configured to dispense powder from the hopper to the outlet.

In some embodiments, the mechanical metering device comprises an auger.

In some embodiments, the apparatus further comprises a loading sock, wherein the loading sock encapsulates the auger and extends at least partially into the hopper.

In some embodiments, the at least one vacuum port comprises a plurality of vacuum ports.

In some embodiments, the plurality of vacuum ports are arranged along an upper portion of the apparatus. In some embodiments, the vacuum ports are arranged along the upper quarter of the hopper.

In another aspect, the present disclosure provides a method of producing a gel for treatment of an oilfield well, the apparatus comprising: providing a mixing fluid stream; providing hydraulic energy to the mixing fluid stream; dispensing a dry polymer to the energized mixing fluid stream; hydraulically mixing the dry polymer and the mixing fluid to produce a concentrated gel; providing a dilution stream; and diluting the concentrated gel with the dilution stream to produce a diluted gel.

In some embodiments, the mixing fluid comprises clean water. In some embodiments, the dilution fluid comprises produced water.

In some embodiments, the method further comprises heating the mixing fluid stream.

In some embodiments, the method further comprises heating the dilution fluid stream.

In some embodiments, the method further comprises: measuring the flow rate of the mixing fluid stream; and measuring the flow rate of the dilution fluid stream.

In some embodiments, the method further comprises adjusting an amount of hydraulic energy applied to the mixing fluid stream based on the measured flow rate of the mixing fluid stream.

In some embodiments, the method further comprises dispensing the dry polymer at a rate dependent on at least one of the flow rate of the mixing fluid stream and dilution fluid stream.

In some embodiments, the method further comprises adjusting an amount of hydraulic energy applied to the mixing fluid stream based on user input.

In some embodiments, the method further comprises dispensing the dry polymer at a rate dependent on at least one of the flow rate of the mixing fluid stream and dilution fluid stream.

In some embodiments, the user input can, for example, include one or more of a desired gel concentration, desired gel viscosity, desired flow rate of either stream, and desired total flow rate.

The present disclosure presents methods and apparatuses for preparing a homogenous viscous gel derived from a dry polymer hydrated with water. Some embodiments in accordance with the present disclosure develop a fully mixed gel for use in subterranean oil well treatments by achieving a level of hydraulic mixing energy that is independent of flow rate such that secondary mechanical mixing is not required.

At least two independent fluid streams, one “clean water” and one “dirty/produced water” are energized by independent pumps. One stream is directed into a mixing device that utilizes the supplied hydraulic mixing energy to effectively hydrate the polymer to produce a concentrated gel. The second stream contains “dirty water”, which can be from a different water source than the first stream. The second stream is mixed with the first after dry polymer has been added to the first stream to make up the remainder of the required flow rate. The addition of the second stream to the first occurs as the streams are directed into a secondary storage tank, which may be, for example, a hydration tank.

By operating the mixing device independently of the dilution stream, sufficient hydraulic mixing energy is available; as a result, both the flow and concentration of hydrated gel can be varied to produce a wide range of quality mixtures for further dilution. The mixing device draws dry polymer from a bulk holding and feeding device, and with sufficient mixing energy, will substantially hydrate the polymer to an extent such that unwanted gel clumps, commonly referred to as “fish-eyes,” are in some embodiments effectively absent.

In addition, some embodiments include a system to mitigate the formation of airborne dry polymer particulate. Systems in accordance with such embodiments, during operation and refilling of the hopper, make use of the vacuum inherently generated by the mixing device during operation to induce airflow through the hopper system to capture any airborne product while also breaking the non-zero pressure differential across the bulk dry polymer holding device and metering device to ensure accurately delivered product.

In various embodiments, while loading the bulk holding device with dry additive, a reclaim vacuum system is attached by means of the dry polymer bulk transport trailer to the top of the bulk hopper.

The combination of the onboard vacuum system and external reclaim vacuum system allow for less dust to be produced during loading, operation, refilling, and emptying of the storage hopper. Some embodiments are able to achieve effectively dust free operation during loading, operation, refilling, and emptying of the storage hopper.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the accompanying figures:

FIG. 1 is a schematic diagram of an apparatus for mixing the viscous gel, in accordance with an example embodiment;

FIG. 2 is a schematic diagram of the water supplies of FIG. 1, according to an example embodiment;

FIG. 3 is a schematic diagram of the hydraulic energy stream of FIG. 1;

FIG. 4 is a schematic diagram of the mixing unit of FIG. 1, according to an example embodiment;

FIG. 5 is a schematic diagram of a polymer dispersion piping section, according to an example embodiment;

FIG. 6 is a schematic diagram the axial shear mixer unit of FIG. 1, according to an example embodiment;

FIG. 7 is a schematic diagram of the dilution stream unit of FIG. 1, according an example embodiment;

FIG. 8 is a schematic diagram of the hydration unit of FIG. 1, according to an example embodiment; and

FIG. 9 illustrates a perspective view of an embodiment of dry additive and mixing components in accordance with an example embodiment.

### DETAILED DESCRIPTION

Various embodiments described herein relate to a method and apparatus of continuously creating a homogenous viscous gel for oilfield well treatment processes primarily from, but not by way of limitation, a dry, hydratable polymer and water at a significantly constant mixing energy and with a significantly low development of airborne particulate during the loading, metering and mixing processes. One possible application of the produced viscous gel could be to carry proppant downhole for well stimulation.

In the oilfield servicing industry, treatment of subterranean formations with high viscosity fluids is often beneficial in increasing the productivity of a well. Some of the embodiments described herein relate to a process for producing a viscous aqueous gel from a dry polymer, that can for example be used in the hydraulic fracturing of wellbore formations.

The inventors of the embodiments described herein have identified two technical obstacles concerning the production of a viscous gel from a dry polymer and water. Some of the embodiments presented herein address, at least in part, at least one of these obstacles. Some other embodiments address, at least in part, each of these obstacles. The first obstacle pertains to the mixing, dispersion and homogenization of the polymer in water without the need for mechanical mixing. The second obstacle relates to the development of airborne polymer dust during the loading, metering and mixing processes.

With respect to the mixing process, the challenge of creating a homogenous polymer based gel of suitable quality arises from the nature of the dispersion and hydration of said polymer. Ideally, wetting of the dry polymer should occur evenly with the polymer fully dispersed in water before it has time to hydrate. In the instances where uneven wetting and dispersion occur, globules of dry polymer become surrounded by a coating of hydrated polymer, leaving clumps of unhydrated polymer distributed throughout the gel. These unwanted gel balls, commonly referred to as “fish eyes,” are difficult to avoid without substantial mixing and are detrimental to the intended processes because they hamper efficiency, lead to a non-uniform gel mixture, and can clog valves and equipment.

To avoid the formation of these so-called “fish eyes”, several traditional methods to stabilize the polymer dispersion have been proposed. One method that was widely employed in industry consisted of treating the polymer with a chemically reversible coating to delay hydration of the polymer until full dispersion in the aqueous fluid has occurred. These treatments alter the surface chemistry of the dry polymer and allow it to disperse within the aqueous medium without hydrating. They are sensitive to reversal upon changes in pH, at which point the inhibiting coating would be deactivated and the dispersed polymer would hydrate to produce the desired gel. However, this process requires undesirable expenditures to treat the polymer and a complex process to create a satisfactory gel.

To avoid the procedure given above, industry began suspending the polymer in a hydrophobic hydrocarbon carrier fluid such as diesel fuel. This allows the polymer to fully disperse without hydrating to create a slurry that can be further be used to create a quality, viscous gel. This process has several drawbacks as well. Some well operators object to the presence of the hydrocarbon carrier fluids in the fracturing gel. The hydrocarbon-polymer slurry must be premixed and held on site in storage tanks, which often results in wasted material at the end of a job, or delays when more slurry must be mixed. Increased shipping and cleaning costs arise to facilitate the process, and there are many environmental issues associated with the presence and disposal of hydrocarbon based concentrates.

Ideally, mixing the dry polymer with water on site without the use of surfactants or carrier fluids would yield lower operational costs and would lower the environmental footprint when compared to current industry practices. Some methods to achieve this have been proposed. These methods had several problems primarily arising from insufficient mixing energy which did not adequately disperse the polymer to reliably produce a quality gel. Some more recently developed apparatuses have had markedly more success in continuously mixing dry polymer with water on site. However, these more recent apparatuses have a hydraulic mixing energy that is proportional to the fluid flow rate, and as such there is a possibility that gel quality may vary with fluid flow rate, i.e. at low flow rates, more fish eyes may develop beyond the tolerable limit.

This issue arises primarily because there are two methods to induce mixing energy into a system; namely by hydraulic energy, which is derived from fluid flow rate, and mechanical energy, which is derived from stirring and shearing devices. When insufficient hydraulic energy is available to adequately mix two or more components, mechanical mixing must be utilized to compensate for this. By introducing mechanical processes into the system, the increased complexity and moving parts leads to a higher possibility of failure and increased maintenance costs, as well as potentially slowing the flow rates to prevent excess stress on the mechanical components. The use of mechanical mixing devices is one of the pervasive issues with existing prior art, and it is desirable to eliminate these aspects from the process.

In addition, since each of the above-described prior systems achieves its flow from a single source of fluid, under certain operational conditions, limitations arising from water quality and temperature control could lead to a loss in gel quality.

With respect to the second technical obstacle associated with dry polymer gel production, it is desirable to reduce or eliminate the development of airborne polymer particulate that may occur during operation. Dry polymer may become airborne during the loading, metering, feeding and mixing processes, and this airborne dust poses a respiratory health risk, as well as a slipping hazard if it comes into contact with moisture. Environmental impact, loss of product, and clean-up costs can also be reduced if a system of mixing is achieved where the polymer can be more efficiently loaded with less of the dry polymer escaping into the environment as airborne dust.

Traditional methods of dust control, such as air filtration systems, cyclone separators, and meshed screens have proven ineffective or unfeasible in this application. Systems, such as those given in prior art U.S. Pat. No. 7635218 B1, may be adequate for permanent, stationary equipment such as what could potentially be found in process plants and manufacturing centers. However, conventional dust control systems for mobile equipment are limited, and as such there is a need to control the development of airborne dust in mobile apparatuses. Dust control precautions are undertaken during the loading, metering, feeding, and mixing processes and it is generally beneficial if such precautions do not hamper mixing efficiency or flow rate. Challenges involved in the development of such a system arise from the fine size of the dry polymer product, its low density, and the generation of static charges during the loading and metering processes.

The present disclosure generally relates to methods and apparatuses for preparing a viscous wellbore treatment gel from a dry polymer and water for use in hydraulic fracturing operations. In some embodiments, the viscous wellbore treatment gel is produced at high flow rates without the development of unwanted gel-balls, commonly referred to as “fish eyes” and achieves a homogenous high quality gel. In addition, in various embodiments described herein, the method and apparatus may be applied continuously without the need to cease production in order to refill the apparatus with dry material and may be operated in such a way as to minimize the developments of airborne polymer particulates during loading, operation, refilling, and emptying. In some embodiments, the gel product exiting this apparatus is fully mixed and has not been allowed additional time to hydrate beyond initial mixing.

Various embodiments shall now be explained with reference to the figures. It should be understood that the figures included are not meant to restrict the scope of the method and apparatus to the embodiments given; rather, they are meant to illustrate how this disclosure can be applied to an apparatus and process that will adequately realize the aforementioned results. It will be apparent to those of skill in the art that other embodiments could be derived that differ in structure from the given example while still keeping the overall processes and ideas described herein relatively constant.

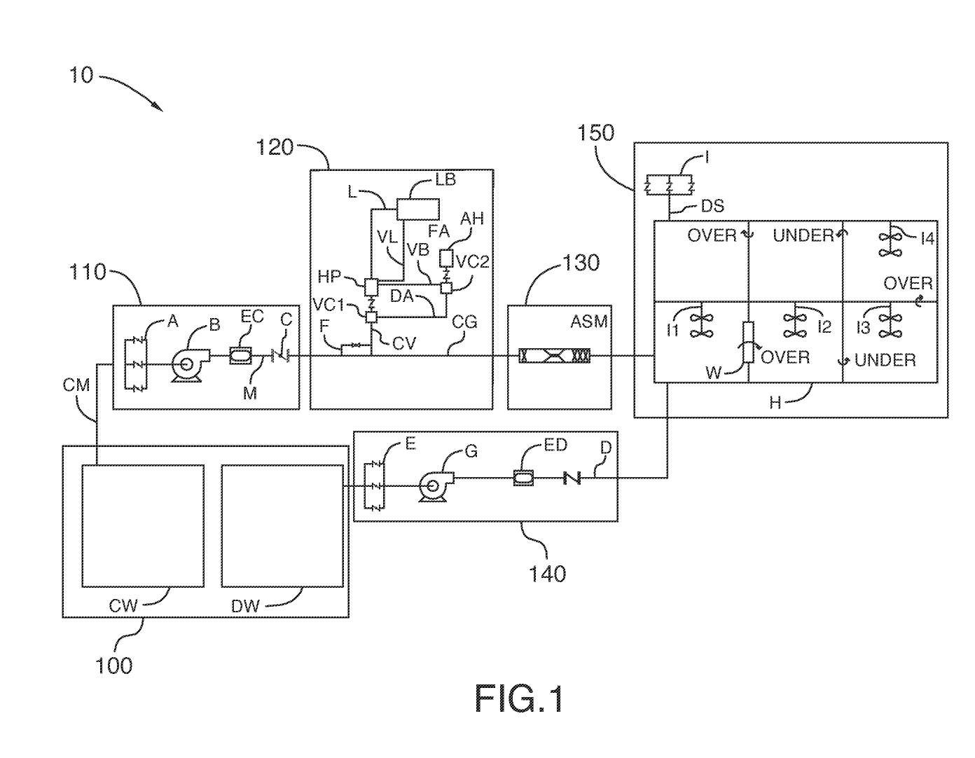

Reference is now made to FIG. 1 which illustrates a schematic diagram of a system 10 in accordance with an embodiment of the present disclosure. System 10 mixes viscous gel through a mixing device with hydraulic energy and subsequent mechanical mixing. System 10 then dilutes the gel and discharge it or stores it, if desired. The process carried out by system 10 will be broken into 6 sections and described in further detail with additional figures.

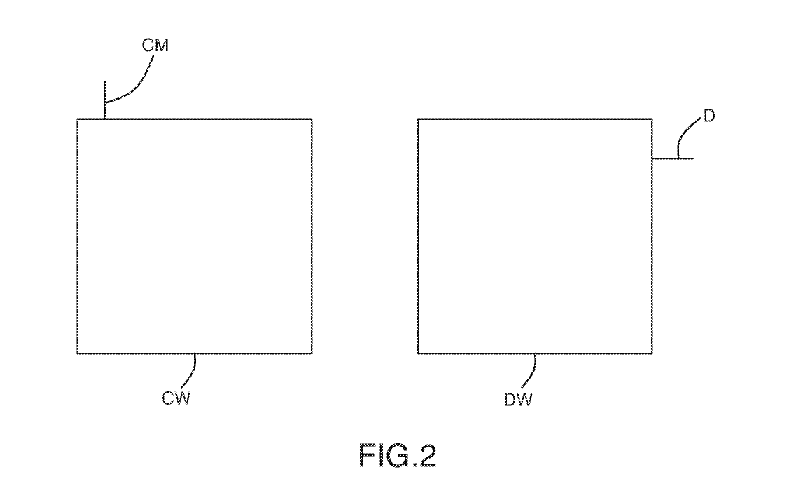

Referring to FIG. 2, which a schematic diagram showing unit 100 of FIG. 1. Unit 100 includes “clean” water supplies CW that may supply water to the clean mixing line CM and “dirty” water supplies DW may supply water to the dilution line D. Dilution line D and clean mixing line CM need not be drawn from the same source. It has been observed that Saline and recirculated water will produce a lower quality gel when compared to clean fresh water; as such, by splitting sources for CM and D, fresh water can be supplied for mixing concentrated gel and “dirty” water can be supplied for dilution. This will reduce clean water consumption by upwards of 85% when based on a 100 bbl/min flow rate operation when compared to a system that only uses clean water.

As used herein the expression “clean water” refers to water from a fresh water source that does not have significant contaminants that would interfere with the gel production source. Examples of clean water include, but are not limited to, untreated water sourced from fresh water bodies such as rivers and lakes. In some embodiments, the term fresh water refers to a liquid that is at least about 95% by mass water.

As used herein the term “dirty water” refers to water that may include contaminates that could interfere with the production of a high quality gel. Examples of dirty water include saline water and produced water. Produced water refers to water that has been previously used in the gel production process and is being used again. Produced water may also be referred to as recirculated water.

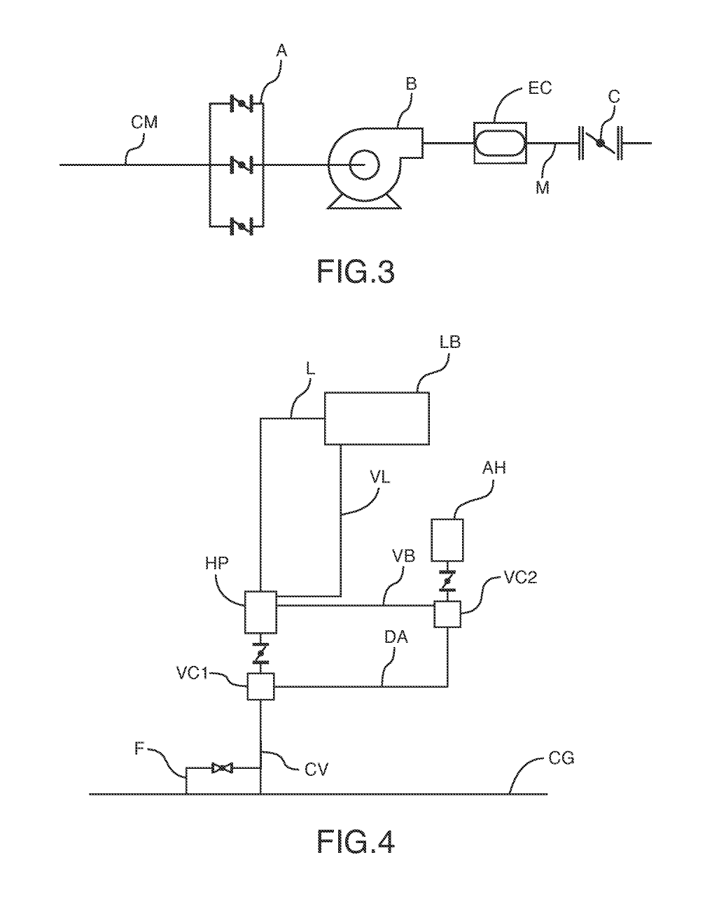

Referring now to FIG. 3, which is a schematic diagram showing unit 110, which may be referred to as the hydraulic energy stream as it provides hydraulic energy to the mixing stream. Pump B in the mixing stream is fed from suction manifold A which may draw fluid from clean water supply CW (shown in FIGS. 1 and 2) through line CM, pump B energizes the mixing stream and is responsible for supplying the clean mixing line M with the required hydraulic mixing energy. The stream passes through a butterfly-type valve such as valve C to further control the flow. A flow meter EC, where in an example embodiment flow meter EC represents an electromagnetic flow meter, is used to precisely measure the flow rate attained from pump B.

Reference is now made to FIG. 4, which is a schematic diagram illustrating unit 120 of FIG. 1, which may be referred to as the mixing unit. Flow meter EC from unit 110 may be used to calibrate the dry polymer feed rate such that the desired concentration of gel is produced from mixing device F. In some embodiments, mixing device F is a device described in U.S. Pat. No. 7,635,218 B1 to Lott, Dec. 2009 and incorporated herein by reference. Dry additive hopper AH may be used for the addition of multiple additives to increase the quality of the concentrated gel. For example, a pH additive (or “pH conditioner”) may be used to optimize fluid pH levels to create the highest quality homogeneous gel, as well silica flour may be added to reduce the likelihood of “fish eyes” forming and increasing the efficiency of which “fish eyes” are broken down by mechanical mixing of the concentrated gel later in the system.

The mechanical mixing utilized in embodiments of the present disclosure is not to be confused with the mechanical mixing device discussed above in relation to known systems. In known systems, the mechanical mixing refers to a device that mixes dry polymer with water. In other words, the mechanical mixing in known systems is used to blend dry polymer with water to produce a gel. In contrast, in embodiments in accordance with the present disclosure, mechanical mixing refers to mixing that occurs post blending (i.e. after the dry polymer has been mixed with water). In other words, the mechanical mixing is performed on the concentrated gel. The concentrated gel passes through the mechanical mixing device in order to, for example, eliminate fish eyes that may have formed.

The pH level of the fluid (e.g. clean water) plays a very important role in the hydration of the polymer. In general, the higher the pH (more basic) of the water, the slower the polymer will hydrate. In various embodiments, two dry additive systems are coupled in series and are further coupled to the same vacuum system. This arrangement allows for a (dry) pH conditioner to be pre-blended the (dry) polymer in AD prior to being mixed with water. In various embodiments, in order to determine the appropriate amount of pH conditioner that is to be utilized, a pH test (which may, for example, be performed in the field or in a laboratory test) is performed on the water that will be mixed with the dry polymer to generate the gel. Instead of blending the pH condition with the dry polymer, the pH condition could be added to the water stream prior to mixing the water with the dry polymer. However, blending the pH conditioner and the dry polymer prior to mixing with water may offer more even chemical distribution and consistency and reduce the production of fish eyes.

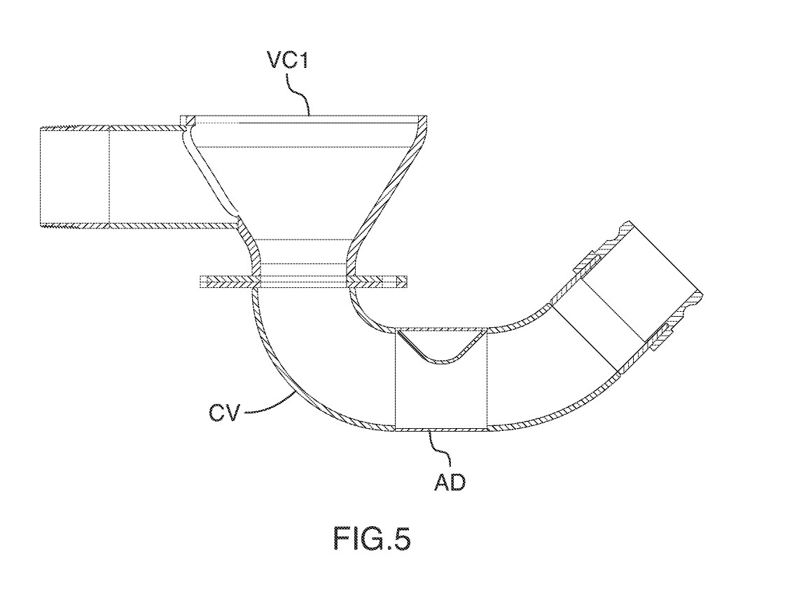

Once the gel has exited mixing device F and additives from additive hopper AH are introduced, it is essentially fully mixed and free of unwanted “fish eyes”. Storage hopper HP is a load sensitive storage hopper by which primary dry powder is discharged from using a mechanical feeder and into a first vacuum chute VC1. Additive hopper AH contains dry additives (pH control, Silica flour) and using a mechanical feeder to discharge into second vacuum chute VC2. The vacuum brake line VB controls dust generated from the various powders during operation by creating a closed vacuum circuit from the top of storage hopper HP, through vacuum brake line VB, through vacuum chute VC2, through the dry additive vacuum line DA, through vacuum chute VC1 and into the mixing device F through the combined vacuum line CV. Combined vacuum line CV contains an evenly dispersed airborne mix of the dry powders with no settlement due to the addition of an inline air deflector AD (shown in FIG. 5) installed at the bottom of vacuum chute VC1. FIG. 5 shows a diagram of inline air deflector AD installed in the piping below vacuum chute VC1. Inline air deflector AD is located at the lowest point of the system and is designed in such a way to create an increase in velocity in order to ensure all dry particles stay dispersed evenly in the air prior to introduction with the liquid stream at mixing device F.

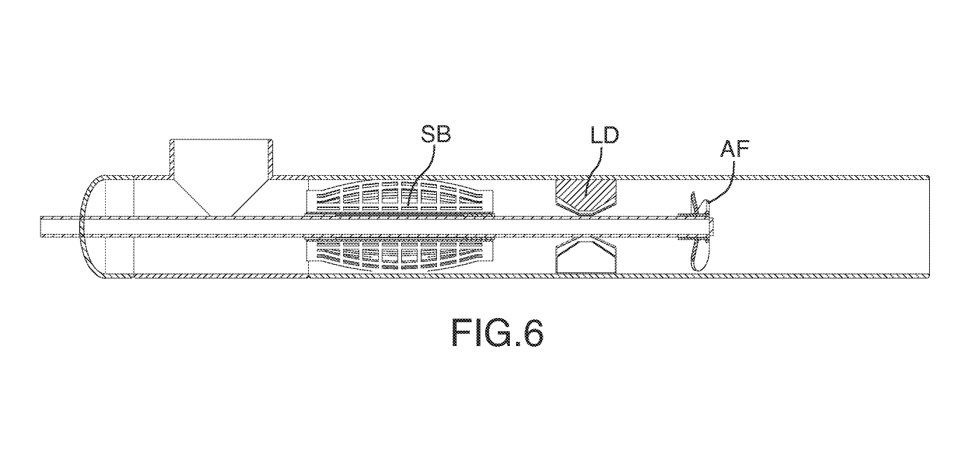

Reference is now made to FIG. 6, which is a schematic diagram showing unit 130 of FIG. 1, which may be referred to as an axial shear mixer unit. Concentrated gel line CG leaves the mixing device F and enters a hydraulically driven Axial Flow Shear Mixing Device ASM. Referring to FIG. 6, the Axial Flow Shear Mixing Device ASM works in 3 parts. An axial flow blade AF will be used to aid in the overall systems efficiency by reducing backpressure on the mixing device F found in FIG. 1 and improving flow across the shear blades SB. Engineered deflectors LD will induce the concentrated gel stream CG (shown in FIGS. 1 and 4) into a laminar flow pattern. A high energy shear blade SB will impart high amounts of mechanical energy into the concentrated gel to eliminate remaining “fish eyes” and ensure optimal dispersion of the powder particulates in the liquid stream so that all dry powder particles will begin hydration prior to tank H (shown in FIG. 8).

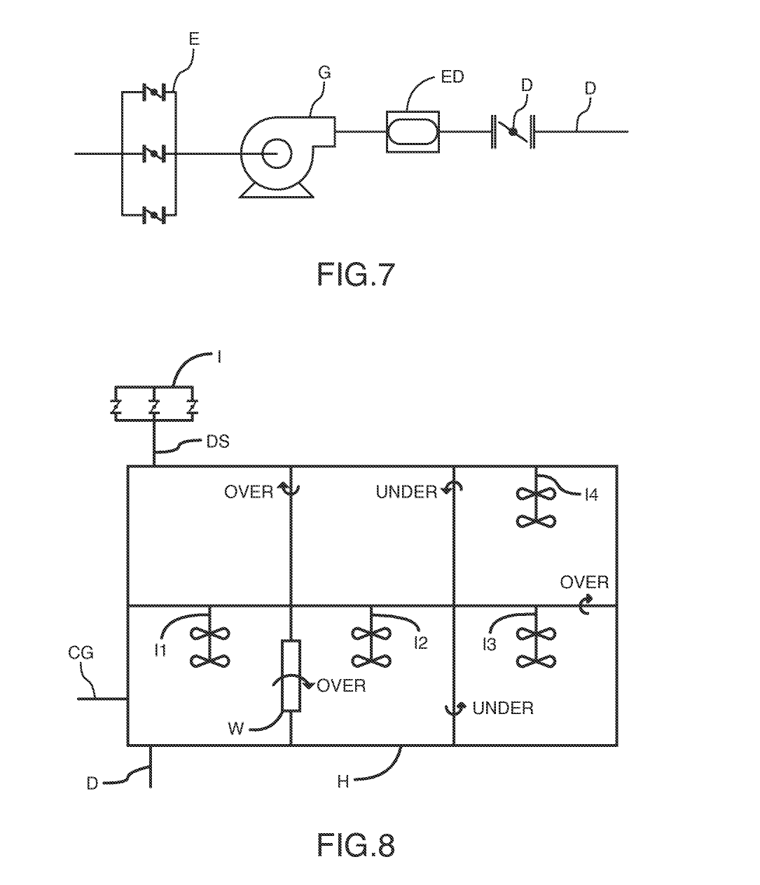

Reference is now made to FIG. 7, which is a schematic diagram showing unit 140 of FIG. 1, which may be referred to as a dilution stream unit. Dilution stream D is energized by pump G, which in an example embodiment is of larger size than pump B, drawing its water through suction manifold E from tank DW (shown in FIG. 2). Pump G serves to dilute the concentrated gel stream CG and make up the required flow rate such that the required downhole gel flow rate can be maintained. For example, consider a situation in which a downhole gel concentration of 20 lbs/1000 gallons with a downhole flow rate of 4200 gallons per minute is required. If the mixing device is operating at a flow rate 630 gal/min and dry polymer is being fed at a rate of 84 lbs/min, pump G would need to supply a flow rate of 3,570 gallons per minute. In some embodiments, the required flow rate, polymer feed rate, dilution rate, etc. are all controlled by an automated system that accurately meters all the variables and adjusts them to meet the desired specifications set by the operator.

By splitting streams CM (shown in FIGS. 1 and 3) and D, a homogenous gel free of fish eyes can be achieved for virtually all required flow rates and concentrations, since dilution flow energy and mixing flow energy are independent. Since streams CM and D are defined as being independent, it is possible to supply each stream from a different water source. This is beneficial under certain operating conditions where water quality and temperature are subject to change. As previously noted, fresh water can be used for stream CM to produce a high quality gel, however, by isolating the stream D and by supplying it with a secondary water source DW, the use of excessive volumes of fresh water can be avoided. The secondary water source can, for example, be dirty water such as produced water. This presents an advantage over traditional methods by allowing recirculated and/or produced water to be used to make up the majority of the required flow rate without sacrificing gel quality. This significantly decreases the environmental footprint and operational costs of the procedures when compared with common industry practices. The above mentioned process can save upwards of 85% of the clean water required for a 100 bbl/min total flow rate job.

The use of independent water sources is also especially useful when source water and/or ambient temperatures are low. The polymer hydration process is inherently thermally activated, and as such, when temperatures drop hydration rate decreases which can lead to problems with gel production. By splitting streams CM and D, water storage CW (shown in FIG. 2) can be thermally regulated to produce an ideal gel without the need to expend energy on water storage DW. This reduces energy costs without sacrificing product quality when compared to some traditional methods.

Streams CG and D may or may not meet prior to reaching the secondary storage tank, which in the embodiment shown is represented by hydration tank H (shown in FIGS. 1 and 8). The combining of the two streams is for dilution purposes only; by the time the concentrated gel stream CG exits the Axial Flow Shear Mixing Device ASM it is essentially fully mixed. The system described can operate at a sufficient flow velocity such that by the time mixing stream CG reaches hydration tank H, essentially no unaccounted hydration has occurred due to a minimal time elapse between mixing and arriving in hydration tank H. As such, the amount of hydration time can be more accurately measured and controlled than with some traditional methods.

Reference is now made to FIG. 8, which is a schematic diagram showing unit 150 of FIG. 1, which may be referred to as the hydration unit. The hydration tank H is divided into 6 compartments that force the fluid into an “over/under” flow path while being further exposed to mechanical mixing energy in the first 4 compartments. The mixing impellers are specifically tailored for their compartments in relation to the fluid path, Compartment one mixing impeller I1 will influence an upward flow path, compartment two mixing impeller I2 will influence a downward flow path, compartment three mixing impeller I3 will influence an upward flow path, and compartment 4 mixing impeller I4 will influence a downward flow path. The combined fluid stream of CG and D will travel over a weir W between compartments one and two. This will create a thin fluid cross section allowing any entrapped air bubbles from the mixing processes to be released ensuring a higher quality homogeneous gel. The fully hydrated gel will leave compartment six by means of a discharge sump DS and through discharge manifold Ito a subsequent unit.

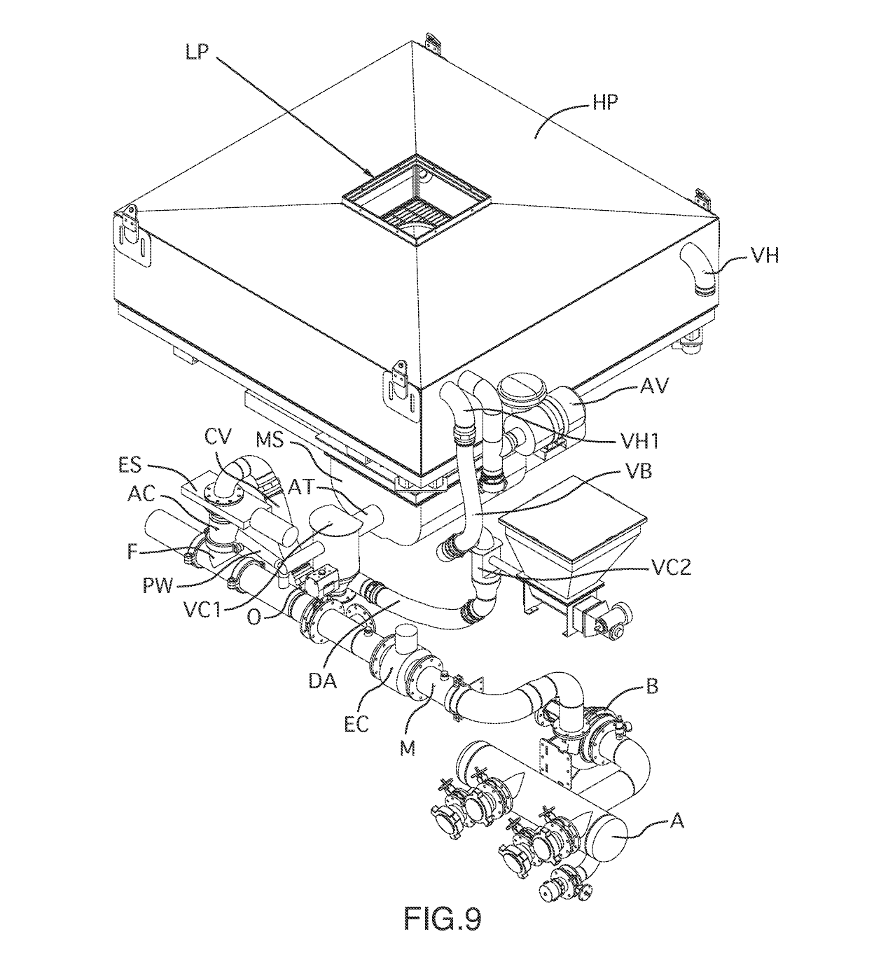

Referring now to FIG. 9, which illustrates a perspective view of an embodiment in accordance with the present disclosure. More specifically, FIG. 9 illustrates an embodiment of the dry additive and mixing aspects of the present disclosure. The embodiment of FIG. 9 can be combined with the dilution and hydration elements that are described in the present embodiment.

Hopper HP represents the bulk dry polymer holding devise pictured in this instance as a prismatic hopper. Hopper HP can be loaded with dry product through loading port LP, where the primary design is such that loading occurs through mechanical means only, e.g. through the use of an auger or conveyor. Traditional industry practices of dry additive bulk transfer usually convey product by the use of compressed air or similar. This method of transfer is one of the underlying causes of the undesirable generation of dust that occurs, and as such the apparatus described herein provides a viable alternative to pneumatically loading the dry product. It is the intent of some of embodiments disclosed herein to solve, at least in part, the challenges associated with dust control in the context of mobile dry additive mixing.

In an example embodiment, dry product is loaded through loading port LP by an external auger, where a 6′ “loading sock” is attached to the end of the auger and extends into port LP. Said loading sock does not need to be hermetically sealed and may hang freely into hopper HP through loading port LP during the loading process when the apparatus is not operating, a vacuum suction is applied to hopper HP through vacuum hookup VH, where VH is attached to an external vacuum source described later. In some embodiments, a plurality of vacuum hookups VH are utilized. In various embodiments, the vacuum hookup(s) VH is/are arranged along the upper quarter of the hopper HP.

The use of the external vacuum source coupled to the vacuum hookup(s) VH generates a net negative pressure differential in hopper HP and induces airflow in the direction from loading port LP to vacuum hookup VH. This will prevent the escape of airborne particles from HP during the loading process. A chain bottom auger feed bulk transport unit LB (shown in FIG. 4) is used to transport, load, and unload the dry product into hopper HP. This is in contrast to known systems that utilize pneumatic delivery systems. An advantage of a mechanical system, such as that disclosed herein, minimize airborne dust particles. Chain bottom auger feed bulk transport unit LB is designed to handle the dry product being used and the auger feed L (shown in FIG. 4) and in some embodiments can reach hopper HP from 35′ away allowing more flexibility for unit placement on location.

Chain bottom auger feed bulk transport unit LB also has the capability of dustless operation with an onboard cyclone vacuum system that keeps itself as well as hopper HP dustless during loading and unloading. Bulk transport unit vacuum line VL (shown in FIG. 4) connects with an external vacuum, such as the one coupled to vacuum hookup VH during loading and unloading to create this dust free transfer. Alternatively, in some embodiments, bulk transport unit vacuum port could also be connected with vacuum generated by the hydraulic mixing device F, such as for example, through vacuum brake line VB. This could be particularly useful in situations where the hopper HP is being replenished (e.g. before it has been completely depleted) during operation of the mixing device F.

From hopper HP, a mechanical metering system MS delivers an accurately metered quantity of dry polymer. In an example embodiment, mechanical metering system MS may be, but not by way of limitation a volumetric feeder consisting of a rotating auger and the associated equipment and housing. Said system may be calibrated prior to use to ensure accuracy. Volumetric feeder MS transports dry material, possibly at a rate between 20 lb/min and 180 lb/min, to chamber VC1 through auger tubing AT. Chamber VC1 may be equipped with a slam-gate type emergency shut valve to prevent the backflow of water into hopper HP in the case of an incident.

The educator nozzle of mixing device F can generate a near perfect vacuum during operation due to Bernoulli's principle, and as such, the negative gage pressure differential induces suction in the dry additive hose CV. This suction draws the dry additive mix from VC1, through orifice O and into hose CV where it is then fed into mixing device F as per the reference cited above. The negative gage pressure induced by the mixing device is also utilized as a “vacuum breaker” to facilitate the dust-free operation and to ensure an accurate delivered product. The suction pressure is broken by attaching hose CV, through chamber VC1, through dry additive vacuum line DA through vacuum chute VC2, through vacuum brake line VB to vacuum hookup VH1 located at the top of HP. This process breaks the negative pressure differential across the auger and prevents the suction induced by mixing device F from pulling material through the auger, as opposed to letting the material be fed exclusively by the motion of the auger. The suction pressure is instead applied at the top of hopper at vacuum hookup VH1, and air is allowed to flow into the hopper from air vent AV and loading port LP and thereby through the above connections any dust generated from the operation or reloading of hopper HP is captured and directed into mixing device F. This allows for a dustless operation as well as maximum utilization of dry polymer as all particulates are captured and used for mixing. It should be noted that components hose CV, dry additive vacuum line DA, and vacuum brake line VB are defined as statically grounded flexible hoses in the present embodiment, but it should be understood that other materials may be used. Air vent AV may be any opening and applicable system of connections into the body of the hopper that allows air to flow free into the system without allowing dry product to spill from hopper HP. Air vent AV may comprise a single opening or a plurality, and they may be located in an suitable manner that allows air to flow free into the system without allowing dry product to spill from hopper HP.

In some embodiments, dry additive column AC can be regulated by an emergency shutoff ES. In the illustrated embodiment, emergency shutoff ES is represented by a knife gate. Emergency shutoff ES acts as an emergency valve to arrest the flow of water in the event that the backpressure generated by mixing device F overcomes the pressure upstream in line M. In the instance of such an event, water will begin to flow up additive column AC where it may meet the dry polymer travelling in hose CV. If the flow of water is not stopped by emergency shutoff ES, water flow may continue further into the system clogging vacuum line CV, vacuum chute VC1, metering system MS, and into hopper HP with a heavily concentrated water gel slurry. This emergency shutoff ES is positioned in such a way to minimize downtime associated with a backpressure overflow and subsequent shutdown.

Dry additive hose CV feeds mixing column AC through knife gate ES and subsequently mixing device F, where the mixing device F is as described above. Mixing device F may prewet the polymer by drawing fluid through pipe PW, then shears and fully mixes the components creating a homogenous gel substantially free of fish eyes. Mixing device F is fed by mixing stream M, which is energized by pump B. Pump B controls the flow rate of water through mixing device F thus defining the mixing energy of mixing device F. If desired, the pump can be set to operate at a constant flow rate; the speed of the auger in metering system MS is then varied (thus varying the dry polymer feed rate) to produce different concentrations of gel. The reverse of this procedure may also be employed to vary the concentration of the gel, or, a combination of both auger and pump speed may be used. In an example embodiment, pump B is operated at a constant flow rate in order to keep a constant mixing energy through mixing device F. The flow rate of water supplied by pump B may be metered by a flow meter such as, but not limited to, electromagnetic flow meter EC.

Pump B draws water from suction manifold A, which is in turn supplied by an external water source, preferably of fresh water supply CW.

To facilitate dust free mixing, it is preferable for the dry polymer to be fully fluidized during the feeding process to reduce friction and static buildup. This also has the added benefit of ensuring a smooth stream of polymer feed for accurate metering. The polymer may be agitated by means such as, but not limited to, commercial vibratory pads which utilize aeration and vibration to improve the flow ability of dry, powdered materials. This is completed by the motion of the auger in metering system MS and may be aided by other means of fluidization if required by the operational parameters. The dust that is born as a result of the applied airflow is mitigated by the dust control system described herein. It should be understood that other means of fluidization, such as compressed air, secondary augers, vibrating components, etc. could be utilized effectively with standard engineering knowledge and it is not by way of restriction that the specified vibratory pads were illustrated.

It is important to note that the dust free mixing system ascertained herein operates at an efficiency such that the hopper HP may be loaded during continuous operation while the mixing device and feeding system are both working without the development of airborne product. The loading method used during operation is identical to the aforementioned where a mechanical, external auger and loading sock deposit dry polymer from a secondary storage bulker LB into hopper HP through loading port LP. As previously noted, loading is accomplished without the use of compressed air or gases, which is contrary to many common industry practices. By utilizing mechanical loading methods and the described dust control techniques, loading during continuous operation can be achieved without detrimental effects. To load during continuous operation, it is not normally required to use the external vacuum hookup VH unless desired. In some embodiments, the vacuum generated by the mixing device F and transmitted through components ES, vacuum chute VC1, dry additive vacuum line DA, vacuum chute VC2, vacuum brake line VB, and vacuum hookup VH, in that order, is sufficient to provide a dust free loading during continuous operation. This feature improves efficiency, as many fracturing operations require multiple refills of the hopper to complete a single stage.

The above-described embodiments are intended to be examples only. Alterations, modifications and variations can be effected to the particular embodiments by those of skill in the art without departing from the scope, which is defined solely by the claims appended hereto.

What is claimed is:

1. An apparatus for producing a gel for the treatment of an oilfield well, the apparatus comprising:
a mixing fluid stream, the mixing fluid stream comprising:
a mixing fluid inlet for accepting a mixing fluid;
a first pump;
a dry polymer inlet for accepting a dry polymer;
a hydraulic mixer configured and adapted to mix the dry polymer with the mixing fluid to produce a concentrated gel;
a dilution fluid stream for diluting the concentrated gel to produce a diluted gel, the dilution fluid stream comprising:
a dilution fluid inlet for accepting a dilution fluid;
a second pump; and
an outlet coupled to the mixing fluid stream.

2. The apparatus of claim 1, wherein the mixing fluid comprises clean water.

3. The apparatus of claim 1, wherein the dilution fluid comprises produced water.

4. The apparatus of claim 1, further comprising a first heater coupled to the mixing fluid stream for heating the mixing fluid.

5. The apparatus of claim 1, further comprising:
a first flow meter coupled to the mixing fluid stream; and
a second flow meter coupled to the dilution fluid stream.

6. The apparatus of claim 5, further comprising a processor coupled to the first flow meter, the second flow meter, the first pump and the second pump, the processor configured to control the first pump based on an output of the first flow meter and an output of the second flow meter.

7. The apparatus of claim 6, further comprising:
a dry polymer storage hopper; and
a volumetric feeder coupled to the dry polymer storage hopper and the dry polymer inlet.

8. The apparatus of claim 7, wherein the processor is further configured to control the volumetric feeder based on at least one of the output of the first flow meter and the output of the second flow meter.

9. The apparatus of claim 6, further comprising an input device configured to accept user input.

10. The apparatus of claim 9, wherein the user input comprises parameters of operation of at least one of the first pump and the second pump.

11. The apparatus of claim 1, further comprising a dry polymer dispensing apparatus comprising:
a hopper having a loading port configured to receive a powder;
at least one vacuum port adapted and configured to be coupled to a vacuum apparatus;
a powder outlet configured to emit powder; and
a mechanical metering device configured to dispense powder from the hopper to the outlet.

12. The apparatus of claim 11, wherein the dry polymer dispensing apparatus further comprises an outlet chamber between the metering device and the outlet chamber.

13. The apparatus of claim 12, further comprising a vacuum-breaking channel coupled between the hydraulic mixer and the outlet chamber; and wherein when in use, the hydraulic mixer generates a vacuum.

14. An apparatus for dispensing a powder, the apparatus comprising:
a hopper having a loading port configured to receive a powder;
at least one vacuum port adapted and configured to be coupled to a vacuum apparatus;
a powder outlet configured to emit powder; and
a mechanical metering device configured to dispense powder from the hopper to the outlet.

15. The apparatus of claim 14, wherein the mechanical metering device comprises an auger.

16. The apparatus of claim 15, further comprising a loading sock, wherein the loading sock encapsulates the auger and extends at least partially into the hopper.

17. A method of producing a gel for treatment of an oilfield well, the apparatus comprising:
providing a mixing fluid stream;
providing hydraulic energy to the mixing fluid stream;
dispensing a dry polymer to the energised mixing fluid stream;
hydraulically mixing the dry polymer and the mixing fluid to produce a concentrated gel;
providing a dilution stream; and
diluting the concentrated gel with the dilution stream to produce a diluted gel.

18. The method of claim 17, further comprising:
measuring the flow rate of the mixing fluid stream; and
measuring the flow rate of the dilution fluid stream.

19. The method of claim 18, further comprising adjusting an amount of hydraulic energy applied to the mixing fluid stream based on the measured flow rate of the mixing fluid stream.

20. The method of claim 18, further comprising dispensing the dry polymer at a rate dependant on at least one of the flow rate of the mixing fluid stream and dilution fluid stream.
